(19) United States
(12) Patent Application Publication
(10) Pub. No.: US 2026/0270876 A1
(43) Pub. Date: Sep. 10, 2026

(54) MEASUREMENT RULES FOR CELL RESELECTION MEASUREMENTS WITH LOW POWER WAKE-UP RECEIVER

(71) Applicant: Intel Corporation, Santa Clara, CA (US)

(72) Inventors: Seau S. Lim, Swindon (GB); Yingyang Li, Beijing (CN); Yi Wang, Beijing (CN); Yujian Zhang, Beijing (CN); Youn Hyoung Heo, Sunnyvale, CA (US)

(21) Appl. No.: 19/162,343

(22) PCT Filed: Apr. 3, 2024
(86) PCT No.: PCT/US2024/022796

§ 371 Date: Sep. 4, 2025

Related U.S. Application Data
(60) Provisional application No. 63/494,176, filed on Apr. 4, 2023.

(51) Int. Cl. H04W 52/02; H04B 17/318; H04W 76/28

(52) U.S. Cl. CPC H04W 52/0235; H04B 17/328; H04W 76/28

(57) ABSTRACT

An apparatus and system are described for use of a Low Power Wake Up Receiver (LP-WUR). Different measurement rules for use of the LP-WUR and a main receiver to monitor a serving cell and inter-frequency and intra-frequency measurements of neighbor cells, dependent on whether all neighbor cells support transmission of a low power synchronisation signal (LP-SS) and a low power wake-up signal (LP-WUS). LP-WUS monitoring by the LP-WUR is used to perform serving cell measurements and all neighbor cell measurements when all neighbor cells support the transmission. Otherwise, intra-and inter-frequency Reference Signals Received Power (RSRP) and Reference Signals Received Quality (RSRQ) thresholds and serving cell quality are used to determine whether the UE is to remain in LP-WUS monitoring as well as which layers to monitor.

### PRIORITY CLAIM

This application claims the benefit of priority to U.S. Provisional Patent Application Ser. No. 63/494,176, filed Apr. 4, 2023, which is incorporated herein by reference in its entirety.

### BACKGROUND

Mobile communication has evolved significantly from early voice systems to highly sophisticated integrated communication platform. Next-generation (NG) wireless communication systems, including 5^{th} generation (5G) and sixth generation (6G) or new radio (NR) systems, are to provide access to information and sharing of data by various users (e.g., user equipment (UEs)) and applications. NR is to be a unified network/system that is to meet vastly different and sometimes conflicting performance dimensions and services driven by different services and applications. As such the complexity of such communication systems has increased. As expected, a number of issues abound with the advent of any new system, including complexities related to cell reselection measurement.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1A illustrates an architecture of a network, in accordance with some aspects.

FIG. 1B illustrates a non-roaming 5G system architecture in accordance with some aspects.

FIG. 1C illustrates a non-roaming 5G system architecture in accordance with some aspects.

FIG. 2 illustrates a block diagram of a communication device in accordance with some aspects.

FIG. 3 illustrates enhanced measurement rules using LP-WUR for serving cell measurement not considering relaxed measurement criteria in accordance with some aspects.

FIG. 4 illustrates enhanced measurement rules using LP-WUR for serving cell measurement considering not-in-cell-edge criterion as relaxed measurement criteria in accordance with some aspects.

FIG. 5 illustrates enhanced measurement rules using LP-WUR for serving cell measurement considering not-in-cell-edge criterion as relaxed measurement criteria in accordance with some aspects.

FIG. 6 illustrates enhanced measurement rules using LP-WUR for serving cell measurement not considering relaxed measurement criteria in accordance with some aspects.

FIG. 7 illustrates enhanced measurement rules using LP-WUR for serving cell measurement considering not-in-cell-edge criterion as relaxed measurement criteria in accordance with some aspects.

FIG. 8 illustrates enhanced measurement rules using LP-WUR for serving cell measurement considering not-in-cell-edge criterion as relaxed measurement criteria in accordance with some aspects.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

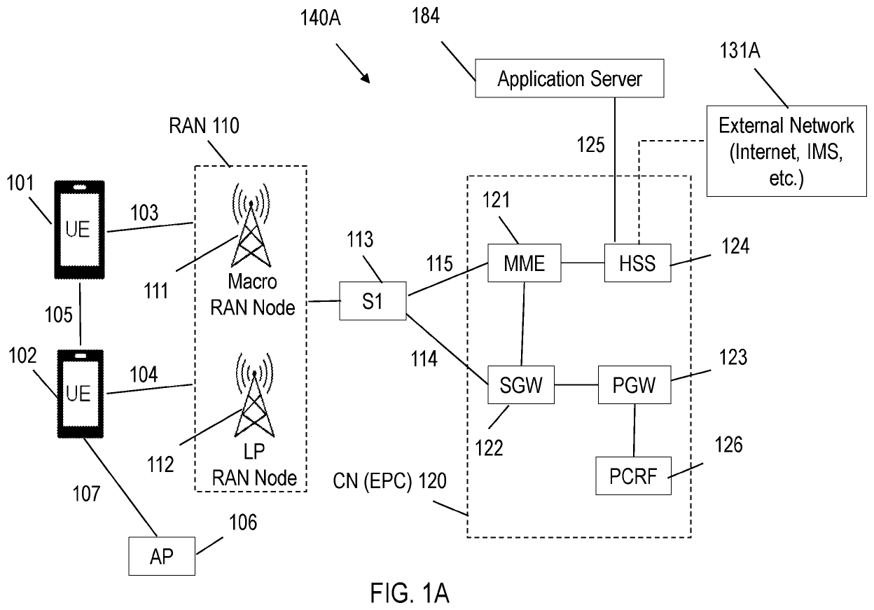

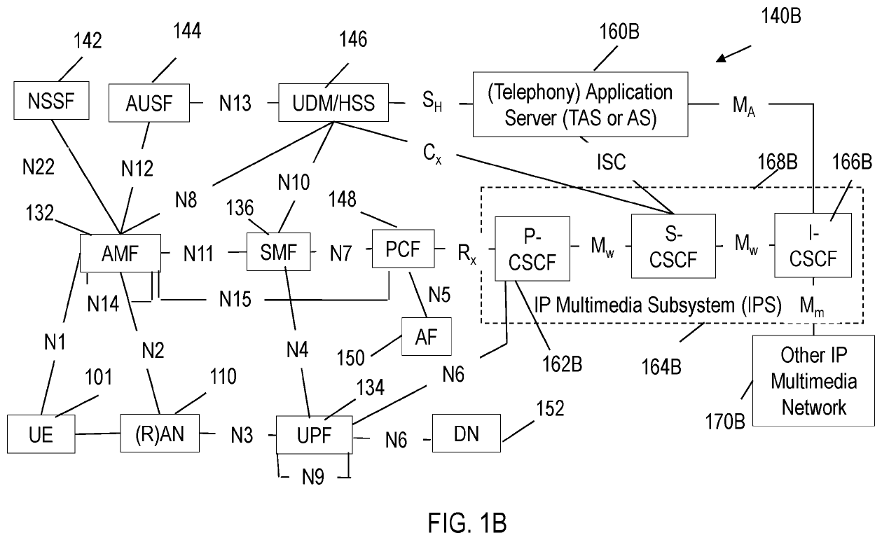

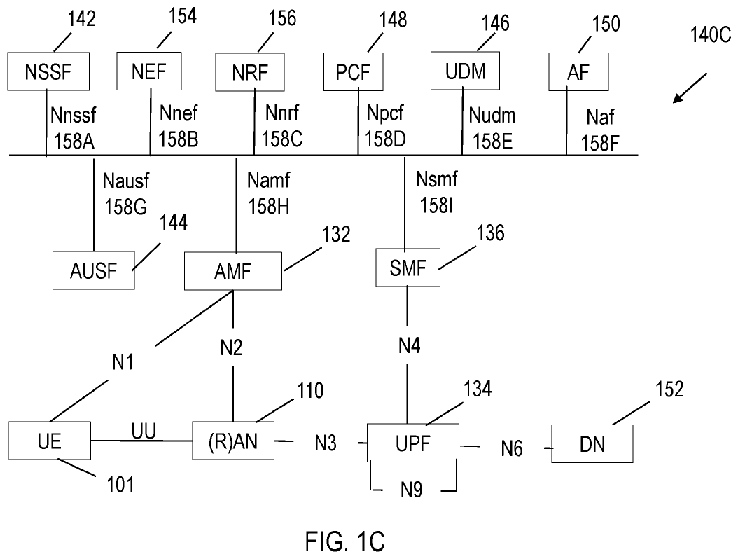

FIG. 1A illustrates an architecture of a network in accordance with some aspects. The network 140A includes 3GPP Long Term Evolution (LTE), 4^{th} generation (4G) and 5^{th} generation (5G) (or next generation (NG)) network functions that may be extended to 6G functions. Accordingly, although 5G will be referred to, it is to be understood that this is to extend as able to 6G structures, systems, and functions. A network function may be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 may be collectively referred to herein as UE 101, and UE 101 may be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and other frequencies and Spectrum Access System (SAS) in 3.55-3.7 GHz and other frequencies). Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and may be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a UMTS protocol, a 3GPP LTE protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) may be referred to as base stations (BSs), NodeBs, evolved NodeBs (eNBs), 5^{th} Generation NodeBs (gNBs), RAN nodes, and the like, and can comprise ground stations (e.g., terrestrial access points) or satellite access nodes (SANs) providing coverage within a geographic area (e.g., a cell) and/or non-terrestrial networks. In some aspects, the communication nodes 111 and 112 may be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and may be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 may be a gNB, an eNB, or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VOIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A may be an IoT network or a 5G or 6G network, including 5G new radio network using communications in the licensed (5G NR) and the unlicensed (5G NR-U) spectrum. One of the current enablers of IoT is the narrowband-IoT (NB-IoT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X communications.

An NG system architecture (or 6G system architecture) can include the RAN 110 and a 5G core network (5GC) 120. The NG-RAN 110 can include a plurality of nodes, such as gNBs and NG-eNBs. The CN 120 (e.g., a 5G core network/5GC) can include an access and mobility function (AMF) and/or a user plane function (UPF). The AMF and the UPF may be communicatively coupled to the gNBs and the NG-eNBs via NG interfaces. More specifically, in some aspects, the gNBs and the NG-eNBs may be connected to the AMF by NG-C interfaces, and to the UPF by NG-U interfaces. The gNBs and the NG-eNBs may be coupled to each other via Xn interfaces.

In some aspects, the NG system architecture can use reference points between various nodes. In some aspects, each of the gNBs and the NG-eNBs may be implemented as a base station, a mobile edge server, a small cell, a home eNB, and so forth. In some aspects, a gNB may be a primary node (MN) and NG-eNB may be a secondary node (SN) in a 5G architecture.

FIG. 1B illustrates a non-roaming 5G system architecture in accordance with some aspects. In particular, FIG. 1B illustrates a 5G system architecture 140B in a reference point representation, which may be extended to a 6G system architecture. More specifically, UE 102 may be in communication with RAN 110 as well as one or more other 5GC network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 may be used to manage access control and mobility and can also include network slice selection functionality. The AMF 132 may provide UE-based authentication, authorization, mobility management, etc., and may be independent of the access technologies. The SMF 136 may be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 may be deployed in one or more configurations according to the desired service type and may be connected with a data network. The PCF 148 may be configured to provide a policy framework using network slicing, mobility management, and roaming (similar to PCRF in a 4G communication system). The UDM may be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162B, a serving CSCF (S-CSCF) 164B, an emergency CSCF (E-CSCF) (not illustrated in FIG. 1B), or interrogating CSCF (I-CSCF) 166B. The P-CSCF 162B may be configured to be the first contact point for the UE 102 within the IM subsystem (IMS) 168B. The S-CSCF 164B may be configured to handle the session states in the network, and the E-CSCF may be configured to handle certain aspects of emergency sessions such as routing an emergency request to the correct emergency center or PSAP. The I-CSCF 166B may be configured to function as the contact point within an operator's network for all IMS connections destined to a subscriber of that network operator, or a roaming subscriber currently located within that network operator's service area. In some aspects, the I-CSCF 166B may be connected to another IP multimedia network 170B, e.g., an IMS operated by a different network operator.

In some aspects, the UDM/HSS 146 may be coupled to an application server 184, which can include a telephony application server (TAS) or another application server (AS) 160B. The AS 160B may be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures may be service-based and interaction between network functions may be represented by corresponding point-to-point reference points Ni or as service-based interfaces.

In some aspects, as illustrated in FIG. 1C, service-based representations may be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein may be used for supporting high reliability in distributed communication systems with dynamic topologies, including sidelink NR V2X communication systems.

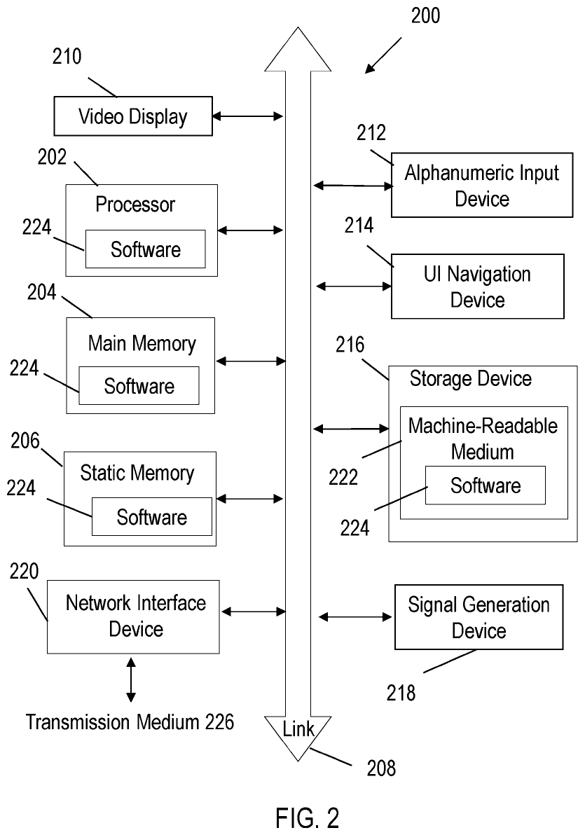

FIG. 2 illustrates a block diagram of a communication device in accordance with some embodiments. The communication device 200 may be a UE such as a specialized computer, a personal or laptop computer (PC), a tablet PC, or a smart phone, dedicated network equipment such as an eNB, a server running software to configure the server to operate as a network device, a virtual device, or any machine capable of executing instructions (sequential or otherwise) that specify actions to be taken by that machine. For example, the communication device 200 may be implemented as one or more of the devices shown in FIGS. 1A-1C. Note that communications described herein may be encoded before transmission by the transmitting entity (e.g., UE, gNB) for reception by the receiving entity (e.g., gNB, UE) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or another sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The non-transitory machine readable medium 222 is a tangible medium. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as IEEE 802.11 family of standards known as Wi-Fi, IEEE 802.16 family of standards known as WiMax, IEEE 802.15.4 family of standards, an LTE family of standards, a UMTS family of standards, peer-to-peer (P2P) networks, a 5G standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single-or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a GSM radio communication technology, a GPRS radio communication technology, an Enhanced Data Rates for GSM Evolution (EDGE) radio communication technology, and/or a Third Generation Partnership Project (3GPP) radio communication technology, for example UMTS, Freedom of Multimedia Access (FOMA), 3GPP LTE, 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), UMTS (3G), Wideband Code Division Multiple Access (UMTS) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), UMTS-Time-Division Duplex (UMTS-TDD), TD-CDMA, Time Division-Synchronous Code Division Multiple Access, 3rd Generation Partnership Project Release 8 (Pre-4th Generation) (3GPP Rel. 8 (Pre-4G)), and subsequent Releases (such as Rel. 9-19, etc.), 3 5G, 5G, 5G New Radio (5G NR), 3GPP 5G New Radio, 3GPP NR NTN (Non-terrestrial NTN), 3GPP LTE Extra, LTE-Advanced Pro, LTE Licensed-Assisted Access (LAA), MuLTEfire, UMTS Terrestrial Radio Access (UTRA), E-UTRA, LTE Advanced (4G), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), PTT, Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as 3GPP Generic Access Network, or GAN standard), Zigbee, Bluetooth(r), Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (I2V) communication technologies, 3GPP cellular V2X, Dedicated Short Range Communications (DSRC) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G 5A (i.e., Operation of ITS-G5 in European ITS frequency bands dedicated to ITS for safety related applications in the frequency range 5,875 GHz to 5,905 GHz), ITS-G 5B (i.e., Operation in European ITS frequency bands dedicated to ITS non-safety applications in the frequency range 5,855 GHz to 5,875 GHz), ITS-G 5C (i.e., Operation of ITS applications in the frequency range 5,470 GHz to 5,725 GHz)), DSRC in Japan in the 700 MHz band (including 715 MHz to 725 MHz), IEEE 802.11bd based systems, etc.

Aspects described herein may be used in the context of any spectrum management scheme including dedicated licensed spectrum, unlicensed spectrum, license exempt spectrum, (licensed) shared spectrum (such as LSA=Licensed Shared Access in 2.3-2.4 GHz, 3.4-3.6 GHz, 3.6-3.8 GHz and further frequencies and SAS =Spectrum Access System/CBRS=Citizen Broadband Radio System in 3.55-3.7 GHz and further frequencies). Applicable spectrum bands include International Mobile Telecommunications spectrum as well as other types of spectrum/bands, such as bands with national allocation (including 450-470 MHz, 902-928 MHz (note: allocated for example in US (FCC Part 15)), 814-894 MHz (note: 3GPP band n26), 703-803 MHz (note: 3GPP band n28), 698-746 MHz (note: lower 700 MHz spectrum in US, 3GPP band n85), 874-925 MHz (note: 3GPP band n100), 450-470 MHz (note: 3GPP bands n31, n72), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHz, 1710-2025 MHz, 2110-2200 MHz, 2300-2400 MHz, 2.4-2.4835 GHz (note: it is an ISM band with global availability and it is used by Wi-Fi technology family (11b/g/n/ax) and also by Bluetooth), 2500-2690 MHz, 698-790 MHz, 610-790 MH, 3400-3600 MH, 3400-3800 MHz, 3800-4200 MHz, 3.55-3.7 GHz (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHz (note: allocated for example in South Korea, 5925-7125 MHz and 5925-6425 MHz band (note: under consideration in US and EU, respectively. Next generation Wi-Fi system is expected to include the 6 GHz spectrum as operating band, but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHz, 3800-4200 MHz, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHz, 37-38.6 GHz, 38.6-40 GHz, 42-42.5 GHz, 57-64 GHz, 71-76 GHz, 81-86 GHz and 92-94 GHz, etc.), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), 57-64/66 GHz (note: this band has near-global designation for Multi-Gigabit Wireless Systems (MGWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHz, and future bands including 94-300 GHz and above. Furthermore, the scheme may be used on a secondary basis on bands such as the TV White Space bands (typically below 790 MHz) where in particular the 400 MHz and 700 MHz bands are promising candidates. Besides cellular applications, specific applications for vertical markets may be addressed such as Program Making and Special Events (PMSE), medical, health, surgery, automotive, low-latency, drones, etc. applications.

As above, 5G systems are designed and developed targeting for both mobile telephony and vertical use cases. In addition to latency, reliability, and availability, UE energy efficiency is also a factor in 5G technologies. Currently, 5G devices may wind up being recharged per week or day, depending on individual's usage time. In general, 5G devices consume tens of milliwatts in the radio resource control (RRC) Idle/Inactive state and hundreds of milliwatts in the RRC Connected state. Designs to prolong battery life are desirable for improving energy efficiency as well as for better user experience.

In order to prolong the battery life, a Low Power Wake Up Receiver (LP-WUR) may be used in 3GPP to improve UE power saving in both the RRC Idle/Inactive state and the RRC Connected state. With LP-WUR, instead of keeping the main receiver on to monitor for any paging for the UE periodically over the UE's discontinuous reception (DRX) cycle and perform a measurement for cell reselection based on measurement rules, the main receiver can be put into ultra-deep sleep with only the LP-WUR being turned on to monitor for any wake-up signal from the network. Use of the LP-WUR may result in power saving at least for not using the main receiver for the waking up (i.e., paging). Power saving for a RRC Idle/Inactive state measurement is described herein.

Existing cell reselection includes (i) measurement rules whether UE is to perform intra/inter-frequency neighbor cell measurements and (ii) cell reselection criteria based on ranking for an intra-frequency neighbor and equal priority inter-frequency neighbor and frequency priority based for inter-frequency neighbor.

For (i), the measurement rules allow the UE to not have to perform an intra-frequency neighbor measurement if the serving cell quality is above Reference Signals Received Power (RSRP) and Reference Signals Received Quality (RSRQ) thresholds (SIntraSearchP and SIntraSearchQ) and performs intra-frequency measurements dependent on the idle mode DRX and frequency range if not above one of the thresholds. For an inter-frequency neighbor measurement, if the serving cell quality is above the RSRP and RSRQ thresholds (SnonIntraSearchP and SnonIntraSearchQ), the UE searches for every layer of higher priority at least every Thigher_priority_search period (inter-frequency period) and performs an inter-frequency measurement for frequency priority of all layers, dependent on the idle mode DRX and frequency range if not above one of the thresholds. For an intra-frequency measurement, the relaxed measurement criteria/conditions are added later in Rel-16 based on not in cell-edge criterion and low mobility criterion to further relax the measurement requirement when the serving cell quality is below the RSRP and RSRQ thresholds. Similarly, for an inter-frequency measurement, the searching for a layer of higher priority when the serving cell quality is better the RSRP and RSRQ thresholds and the searching for layers of all priorities when the serving cell quality is below the RSRP or RSRQ threshold is also further relaxed. For (ii), regardless of Option A and B, the same cell reselection criteria as in the main receiver can be applied.

Several options may be used to enhance the measurement rules that can exploit the use of the LP-WUR for improving the UE power saving on cell reselection measurement. In Option A, the serving cell measurement is performed by the UE via the LP-WUR monitoring the low power wake-up signal (LP-WUS) and/or the LP synchronization signal (LP-SS). Whenever the UE is to perform intra/inter-frequency neighbor cell measurements as per the measurement rules, the UE turns on the main receiver to measure the signals. In Option B, the UE performs serving cell measurements and all neighbor cell measurements in the LP-WUS.

### Option A

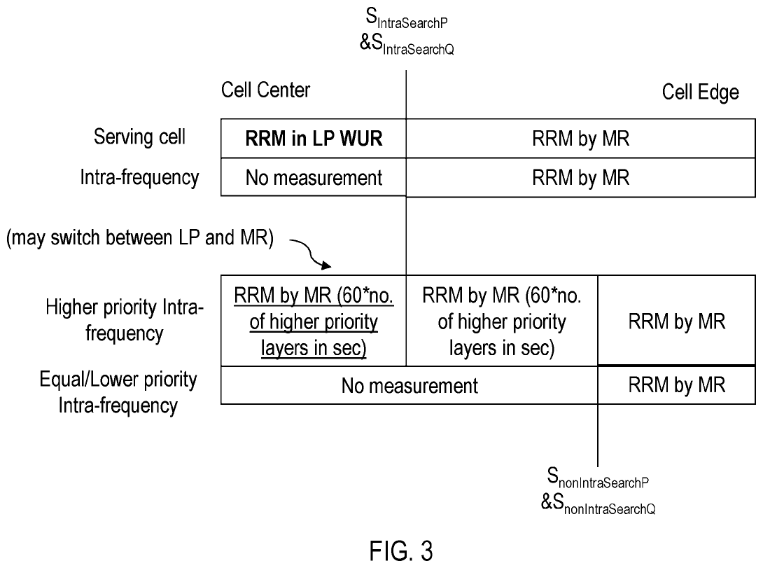

In particular, the serving cell measurement may be performed by the UE monitoring the LP-WUS using the LP-SS and/or the LP-WUS via the LP-WUR. Whenever the UE is to perform the intra/inter-frequency neighbor cell measurements as per the measurement rules, the UE turns on the main receiver (MR) to measure. For an intra-frequency measurement, when the serving cell quality is above the RSRP and RSRQ thresholds (SIntraSearchP and SIntraSearchQ), the UE remains in the LP-WUS monitoring. This is shown in FIG. 3, which illustrates enhanced measurement rules using LP-WUR for serving cell measurement not considering relaxed measurement criteria in accordance with some aspects. In the box in FIG. 3 with the bolded text, the UE is able to turn off the MR and use the LP-WUR and reduce power consumption.

When the serving cell quality is not above the RSRP and RSRQ thresholds (SIntraSearchP and SIntraSearchQ), the UE may turn on the main receiver to perform intra-frequency neighbor cell measurements. The UE may also use the main receiver to perform serving cell measurements. For an inter-frequency measurement, when the serving cell quality is better than the RSRP and RSRQ thresholds (SnonIntraSearchP and SnonIntraSearchQ), the UE may turn on the main receiver and search for every layer of higher priority at least every Thigher_priority_search period.

Based on an initial evaluation in RAN1, if the period to switch to the main receiver (and then switch back to LP mode after the corresponding detection is done) is more than 20 DRX cycles with DRX value=1.28 s, power saving gain is observed, while if the period is small, e.g., N DRX cycles, where N is an integer number, even more power is consumed by switching between the modes than by always keeping the main receiver on (assuming the main receiver is in deep sleep not ultra-deep sleep). Since the Thigher_priority_search period is (60*number of higher priority layers) seconds, a power saving gain using the LP-WUS may still be achievable. This is shown in the box containing the underlined text in FIG. 3, where the UE may turn off the main receiver and stay in the LP-WUR between measurements that are 60*number of higher priority layer apart.

When the serving cell quality is below the RSRP and RSRQ thresholds (SnonIntraSearchP and SnonIntraSearchQ), the UE turns on the main receiver and searches and measures for frequency layers of higher, equal, or lower priority. Radio Resource Management (RRM) by the main receiver for the serving cell measurement is based on Clause 4.2.2.2 in 3GPP TS 38.133v1780 for Srxlev≤S_{IntraSearchP} and Squal≤S_{IntraSearchQ}. RRM by the main receiver for an intra-frequency measurement is based on Clause 4.2.2.3 in 3GPP TS 38.133v1780 for Srxlev≤S_{IntraSearchP} and Squal≤S_{IntraSearchQ}. RRM by the main receiver for an inter-frequency measurement is based on Clause 4.2.2.4 in 3GPP TS 38.133v1780 for Srxlev≤S_{nonIntraSearchP} or Squal≤S_{nonIntraSearchQ}. If Srxlev>S_{nonIntraSearchP} and Squal>S_{nonIntraSearchQ} but Srxlev≤S_{IntraSearchP} and Squal≤S_{IntraSearchQ}, only RRM by the main receiver may be used as in Clause 4.2.2.7 in 3GPP TS 38.133v17.8.0. If Srxlev>S_{IntraSearchP} and Squal>S_{IntraSearchQ}, the UE can switch between the main receiver and the LP-WUR for the inter-frequency measurement for higher priority layers, while performing RRM in the LP-WUR for a serving cell measurement.

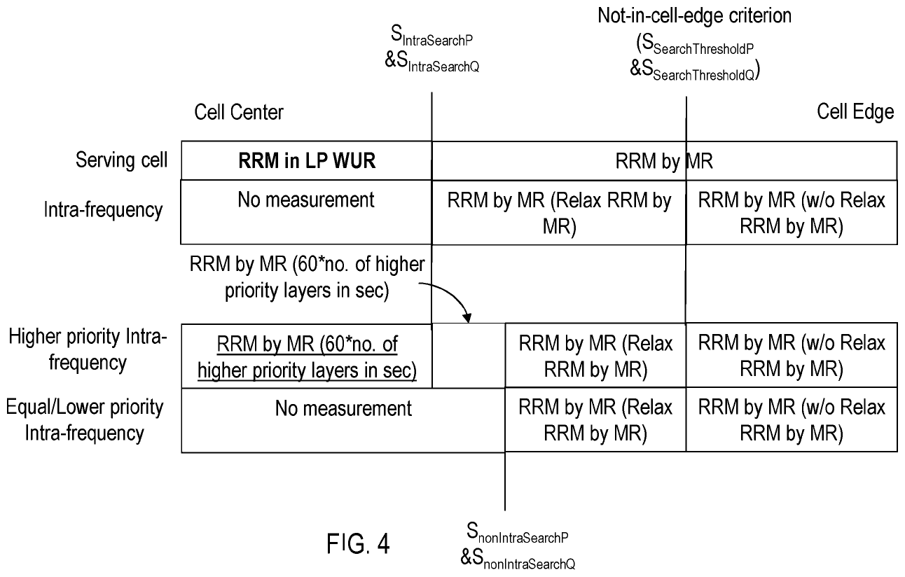

Further relaxed measurement can be applied as before if the criteria (low mobility criterion, not-at-cell edge) are configured and the criteria are fulfilled-which provides power saving when the main receiver of UE is turned on. The interaction between the LP-WUR monitoring and when the UE applies relaxed measurement is shown in the remaining FIGS. of Option A, in which FIG. 4 illustrates enhanced measurement rules using LP-WUR for serving cell measurement considering not-in-cell-edge criterion as relaxed measurement criteria in accordance with some aspects.

In FIG. 4, not-in-cell-edge criterion from the relaxed measurement is configured. FIG. 4 shows that the relaxed intra-frequency RRM is performed by the main receiver when the Not-in-Cell-edge criterion is fulfilled (i.e., Srxlev>S_{SearchThresholdP} and Squal>S_{SearchThresholdQ}). The relaxed intra-frequency RRM is performed by the main receiver in accordance with Clause 4.2.2.9.3 in 3GPP TS 38.133v1780. Similarly, for the inter-frequency RRM, the relaxed measurement kicks in when the Srxlev>S_{SearchThresholdP} and Squal>S_{SearchThresholdQ}. The relaxed inter-frequency RRM is performed by the main receiver in accordance with Clause 4.2.2.10.3 in 3GPP TS 38.133v1780. Again, if Srxlev>S_{IntraSearchP} and Squal>S_{IntraSearchQ}, the UE can switch between the main receiver and the LP-WUR for the inter-frequency measurement for higher priority layers, while performing RRM in the LP-WUR for the serving cell measurement.

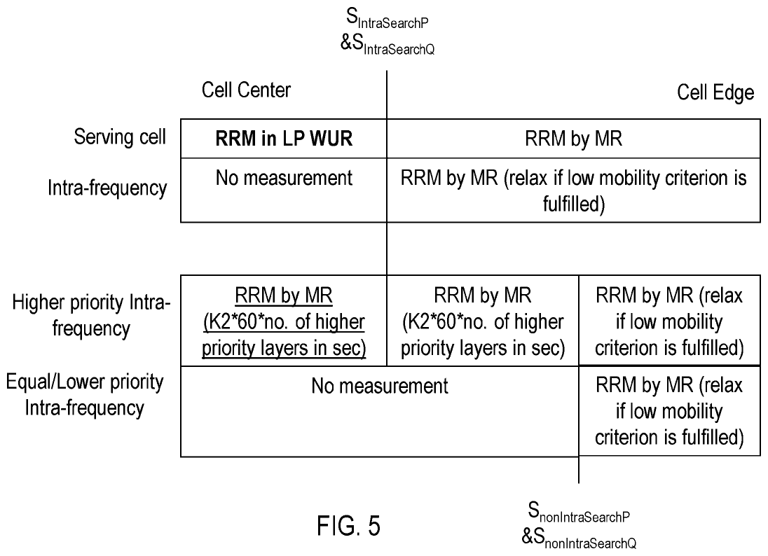

FIG. 5 illustrates enhanced measurement rules using LP-WUR for serving cell measurement considering not-in-cell-edge criterion as relaxed measurement criteria in accordance with some aspects. In FIG. 5, a low mobility criterion from the relaxed measurement is configured. FIG. 5 shows that the relaxed intra-frequency RRM is performed by the main receiver when the low mobility criterion is fulfilled while Srxlev≤S_{intraSearchP} or Squal≤S_{intraSearchQ}. The relaxed intra-frequency RRM is performed by the main receiver in accordance with Clause 4.2.2.9.2 in 3GPP TS 38.133v1780. Similarly, for the inter-frequency RRM, the relaxed measurement for low mobility criterion kicks in when low mobility criterion is satisfied while Srxlev≤S_{nonIntraSearchP} or Squal≤S_{nonIntraSearchQ}. The relaxed inter-frequency RRM is performed by the main receiver in accordance with Clause 4.2.2.10.2 in 3GPP TS 38.133v1780. When the low mobility criterion is fulfilled while Srxlev>S_{nonIntraSearchP} and Squal>S_{nonIntraSearchQ}, the inter-frequency RRM is performed by the main receiver according to Clause 4.2.2.10.3 in 3GPP TS 38.133v1780. Again, if Srxlev>S_{IntraSearchP} and Squal>S_{IntraSearchQ}, the UE can switch between the main receiver and the LP-WUR for the inter-frequency measurement for higher priority layers, while performing RRM in the LP-WUR for the serving cell measurement.

In other embodiments, further relaxation on the measurement for neighbor cells may be employed in all the remaining boxes in FIGS. 3-5 not labeled “no measurement”. With the further relaxation, for one example, the boundary of the box with the bold text is still S_{intraSearchP} & S_{intraSearchQ}. For example, the boundary of the box with the bold text may be extended to S_{SearchThresholdP} & S_{SearchThresholdP} in FIG. 4, if the relaxation factor is sufficiently large to achieve power saving gain via switching between the LP-WUR and the main receiver for the serving cell and the neighbor cell measurement respectively. Furthermore, the boundary of the box with the bold text may be extended to the entire cell coverage including the cell edge in FIG. 5 if the relaxation factor is sufficiently large to achieve power saving gain.

In some embodiments, further relaxation on the measurement may be employed in all the remaining boxes in FIGS. 3-5 not labeled “no measurement”. For example, the cycle for RRM by the main receiver in the remaining boxes may be increased compared to the values in TS 38.133v1780.

In some embodiments, further UE power saving may be achieved via switching between the LP-WUR and the main receiver in between measurements in all the remaining boxes in FIGS. 3-5 not labeled “no measurement” in the case where the periodicity of searching/detection for a new cell and measurement of a detected cell or measuring the serving cell is above M DRX cycles, where M is an integer number. In such cases, the UE may stay in the LP-WUR between those measurements and thus reduce UE power consumption.

In some embodiments, UE power saving may also be achieved via switching between the LP-WUR and the main receiver in between measurements in all the boxes with the bold text in FIGS. 3-5 in the case where the periodicity of searching/detection for a new cell and measurement of a detected cell or measuring the serving cell is above M DRX cycles, where M is an integer number. In such cases, the UE may stay in the LP-WUR between those measurements and thus reduce UE power consumption.

In some embodiments, two sets of thresholds SIntraSearchP and SIntraSearchQ may be used. One set of thresholds is for LR-based RRM, the other set is for MR-based RRM. To switch from the LP-WUR to the main receiver, the set of thresholds for LR-based RRM is used while the set of thresholds for MR-based RRM is used when deciding to switch from the main receiver to the LP-WUR (or switching between the LP-WUR and the main receiver). This set of thresholds for the LR based RRM is sent in a System Information Broadcast (SIB).

In Option A not all neighbor cells may support LP-SS/WUS. However, as the UE may switch between LP-WUS monitoring and the main receiver for neighbor cell measurements, this may have consequences to timing for waking up/paging the UE in both the LP-WUS monitoring and the main receiver by the network.

### Option B

In this option, the UE performs serving cell measurements and all neighbor cell measurements in the LP-WUS. Even though the same measurement rules framework can be applied, the measurement requirements should be specified for the LP-WUR. In this option, all cells support the LP-WUS or at least LP-SS and the LP-WUR is able to measure the LP-SS with at least similar reliability and accuracy as the main receiver and is able to switch between frequencies for inter-frequency measurement.

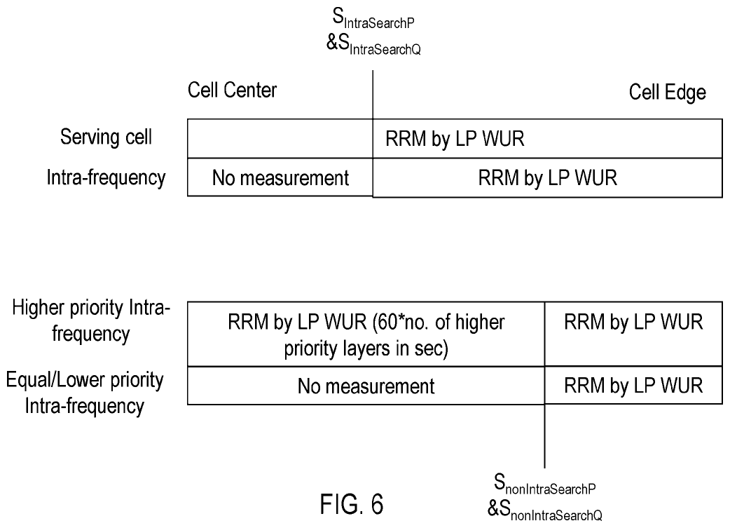

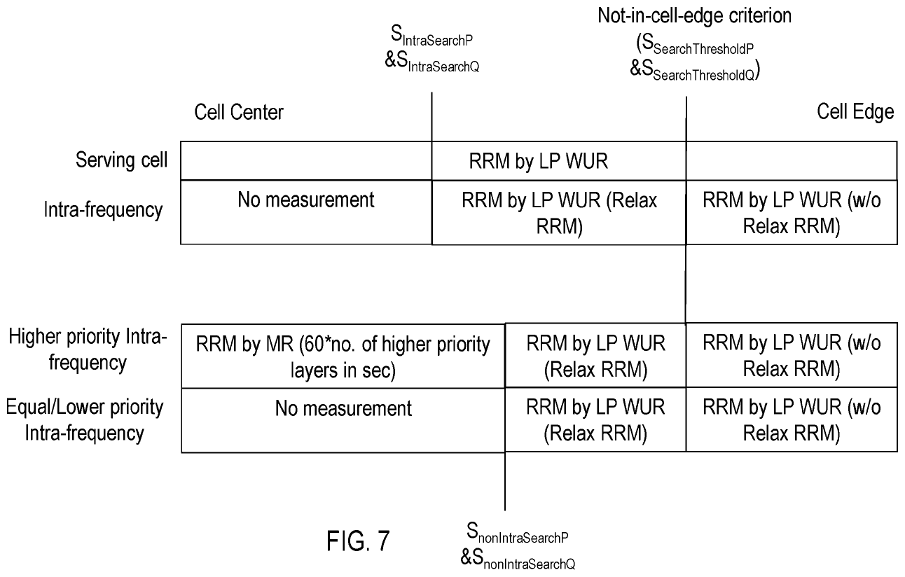

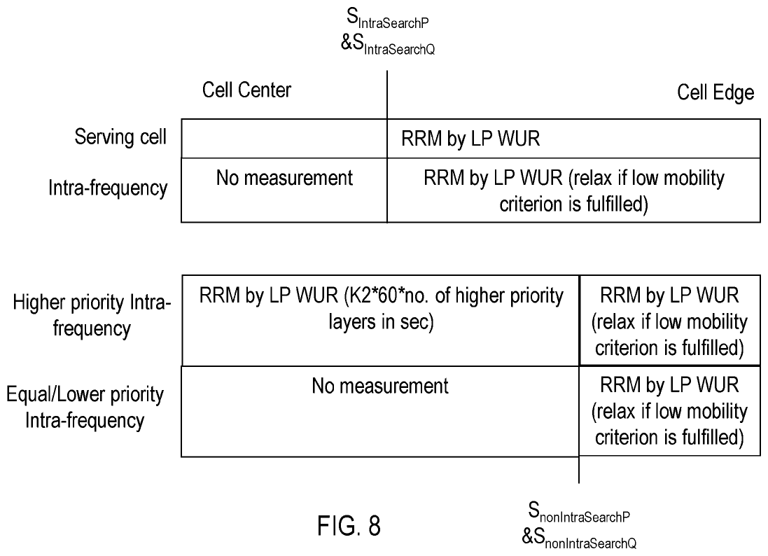

FIGS. 6-8 show LP-WUR is used for the measurements. In particular, FIG. 6 illustrates enhanced measurement rules using LP-WUR for serving cell measurement not considering relaxed measurement criteria in accordance with some aspects. FIG. 7 illustrates enhanced measurement rules using LP-WUR for serving cell measurement considering not-in-cell-edge criterion as relaxed measurement criteria in accordance with some aspects. FIG. 8 illustrates enhanced measurement rules using LP-WUR for serving cell measurement considering not-in-cell-edge criterion as relaxed measurement criteria in accordance with some aspects.

As the thresholds used for measurements are not the same for the main receiver and the LP-WUR, a new set of thresholds SIntraSearchP, SIntraSearchQ, SnonIntraSearchP and SnonIntraSearchQ separate from the thresholds used by the main receiver are used by the UE for deciding when an intra-frequency measurement is to be measured, when to measure higher priority layers only, and when to measure all layers for an inter-frequency measurement. If relaxed measurement criteria are used, new thresholds (SsearchThresholdP & SsearchThresholdQ) for the not-in-cell-edge criterion are set and also new parameter values for low mobility criterion when in use with the LP-WUR.

Option B allows the UE to not switch between LP-WUS monitoring and the main receiver for a neighbor cell measurement; the network can just wake up/page the UE either in LP-WUS monitoring or the main receiver in a cell. However, all neighbor cells are to support LP-SS/WUS. Option B may also be more power consumption efficient than Option A.

For above options (Option A or option B), the UE uses the option based on the gNB configuration, e.g., the gNB configures one of the options using the SIB or UE-specific RRC signaling (a configuration contains the measurement rules). Alternatively, the UE selects one option based on at least one of the following pre-defined rules:
the UE uses the option specified by the standard, or
the UE uses the option depending on whether at least one neighbor cell is not configured with LP-WUS/LP-SS. For example, if the UE identifies the serving cell and all neighbour cells are configured with LP-WUS/LP-SS, the UE may apply option B, otherwise the UE applies option A. In this case, the gNB may support both options and the UE chooses one of the options. The UE may choose the option autonomously, in which case the gNB may support both options and it is up to UE implementation to choose the option.

In some embodiments, the UE may report the capability for option A and/or option B.

For Option A, the network wakes up the UE either via the LP-WUS or via an existing paging mechanism since the network may not know whether the UE is in the LP-WUR or in the main receiver.

### EXAMPLES

Example 1 is an apparatus for a user equipment (UE), the apparatus comprising: processing circuitry to configure the UE to, for a first configuration received from a 5th generation NodeB (gNB): use a Low Power Wake Up Receiver (LP-WUR) to monitor at least one of a low power synchronisation signal (LP-SS) or a low power wake-up signal (LP-WUS) for LP-WUS monitoring of a serving cell; determine whether serving cell quality is above intra-frequency Reference Signals Received Power (RSRP) and Reference Signals Received Quality (RSRQ) thresholds (SIntraSearchP and SIntraSearchQ) and above inter-frequency RSRP and RSRQ thresholds (SnonIntraSearchP and SnonIntraSearchQ); for intra-frequency measurements of a neighbor cell, in response to a determination that the serving cell quality is above the intra-frequency RSRP and RSRQ thresholds, remain in LP-WUS monitoring by the LP-WUR; and for inter-frequency measurements, in response to a determination that the serving cell quality is above the inter-frequency RSRP and RSRQ thresholds, turn on a main receiver and search for every layer of higher priority at least every inter-frequency period; and a memory configured to store the serving cell quality.

In Example 2, the subject matter of Example 1 includes, wherein the processing circuitry configures the UE to: determine whether an overall period to switch from the LP-WUR to the main receiver and then switch back to the LP-WUR after a corresponding detection is performed is more than a switching period of 2 discontinuous reception (DRX) cycles with a DRX value=1.28 s; and for inter-frequency measurements, in response to a determination that the overall period is larger than the switching period, switch from the LP-WUR to the main receiver for the corresponding detection and then switch back to the LP-WUR after the corresponding detection.

In Example 3, the subject matter of Examples 1-2 includes, *number of higher priority layers.

In Example 4, the subject matter of Examples 1-3 includes, wherein the processing circuitry configures the UE to: for the inter-frequency measurements, in response to a determination that the serving cell quality is below the inter-frequency RSRP and RSRQ thresholds, turn on the main receiver and search and measure for frequency layers of higher, equal, or lower priority; and in response to a determination that Srxlev>SIntraSearchP and Squal>SIntraSearchQ, switch between the main receiver and the LP-WUR for the inter-frequency measurement for higher priority layers, and perform radio resource management (RRM) using the LP-WUR for serving cell measurements.

In Example 5, the subject matter of Examples 1-4 includes, wherein the processing circuitry configures the UE to: determine whether not-in-cell edge criterion, Srxlev>SSearchThresholdP and Squal> SSearchThresholdQ, is fulfilled; in response to a determination that the not-in-cell edge criterion is fulfilled, use the main receiver to perform at least one of a relaxed intra-frequency radio resource management (RRM) or a relaxed inter-frequency RRM; and in response to a determination that Srxlev>SIntraSearchP and Squal>SIntraSearchQ, switch between the main receiver and the LP-WUR for an inter-frequency measurement for higher priority layers while performing RRM in the LP-WUR for a serving cell measurement.

In Example 6, the subject matter of Examples 1-5 includes, wherein the processing circuitry configures the UE to: in response to a determination that a low mobility criterion is fulfilled while at least one of Srxlev≤SintraSearchP or Squal≤SintraSearchQ, use the main receiver to perform a relaxed intra-frequency radio resource management (RRM); in response to a determination that the low mobility criterion is fulfilled while at least one of Srxlev≤SnonIntraSearchP or Squal≤SnonIntraSearchQ, use the main receiver to perform a relaxed inter-frequency RRM; and in response to a determination that Srxlev>SIntraSearchP and Squal>SIntraSearchQ, switch between the main receiver and the LP-WUR for an inter-frequency measurement for higher priority layers while performing RRM in the LP-WUR for a serving cell measurement.

In Example 7, the subject matter of Examples 1-6 includes, wherein the processing circuitry configures the UE to extend use of the LP-WUR for radio resource management (RRM) to serving cell quality thresholds SSearchThresholdP and SSearchThresholdP in response to a determination that a relaxation factor is large enough to achieve power saving gain via switching between the LP-WUR and the main receiver for serving cell and neighbor cell measurements.

In Example 8, the subject matter of Examples 1-7 includes, wherein the processing circuitry configures the UE to use a first set of intra-frequency RSRP and RSRQ thresholds for LR-based radio resource management (RRM) to switch from the LP-WUR to the main receiver and a second set of intra-frequency RSRP and RSRQ thresholds for main receiver-based RRM to switch from the main receiver to the LP-WUR.

In Example 9, the subject matter of Example 8 includes, wherein the processing circuitry configures the UE to receive the first set of intra-frequency RSRP and RSRQ thresholds in a System Information Broadcast.

In Example 10, the subject matter of Examples 1-9 includes, wherein at least some neighbor cells do not support transmission of a corresponding LP-SS and LP-WUS.

In Example 11, the subject matter of Examples 1-10 includes, wherein for a second configuration received from the gNB: the processing circuitry configures the UE to use LP-WUS monitoring to perform serving cell measurements and all neighbor cell measurements; and all neighbor cells support transmission of at least one of a corresponding LP-SS or LP-WUS.

In Example 12, the subject matter of Examples 1-11 includes, wherein, for a second configuration received from the gNB, the processing circuitry configures the UE to use different sets of intra-frequency RSRP and RSRQ thresholds and inter-frequency RSRP and RSRQ thresholds for the main receiver and the LP-WUR.

In Example 13, the subject matter of Example 12 includes, wherein the processing circuitry configures the UE to use the different sets of intra-frequency RSRP and RSRQ thresholds to determine whether to perform an intra-frequency measurement, when to measure higher priority layers only for the inter-frequency measurement, and when to measure all layers for the inter-frequency measurement.

In Example 14, the subject matter of Examples 12-13 includes, wherein for relaxed measurement criteria, the processing circuitry configures the UE to use different not-in-cell-edge thresholds (SsearchThresholdP and Ssearch ThresholdQ) for not-in-cell-edge criterion and different parameter values for low mobility criterion for the main receiver than for the LP-WUR.

In Example 15, the subject matter of Examples 1-14 includes, wherein the processing circuitry configures the UE to receive, from the gNB, at least one of a System Information Broadcast or UE-specific radio resource control (RRC) signaling, an indication of which of the first configuration and a second configuration to use.

In Example 16, the subject matter of Examples 1-15 includes, wherein the processing circuitry configures the UE to: determine whether at least one neighbor cell is not configured to transmit the LP-SS and LP-WUS; and select among the first configuration and a second configuration dependent on a determination of whether the at least one neighbor cell is not configured to transmit the LP-SS and LP-WUS.

Example 17 is an apparatus configured to operate as a user equipment (UE), the apparatus comprising: processing circuitry to configure the UE to: receive, from a 5th generation NodeB (gNB) in at least one of a System Information Broadcast or UE-specific radio resource control (RRC) signaling, control signaling that indicates which of a first configuration and a second configuration to use, the first configuration and the second configuration indicating measurement rules for use of a Low Power Wake Up Receiver (LP-WUR) and a main receiver to monitor a serving cell and inter-frequency and intra-frequency measurements of neighbor cells; and dependent on which of the first configuration and the second configuration is to be used and serving cell quality, select among the LP-WUR and the main receiver to monitor at least one of a low power synchronisation signal (LP-SS) or a low power wake-up signal (LP-WUS) for at least one of the serving cell or neighbor cells; and a memory configured to store the serving cell quality.

In Example 18, the subject matter of Example 17 includes, wherein for the first configuration, the processing circuitry configures the UE to: determine whether the serving cell quality is above intra-frequency Reference Signals Received Power (RSRP) and Reference Signals Received Quality (RSRQ) thresholds (SIntraSearchP and SIntraSearchQ) and above inter-frequency RSRP and RSRQ thresholds (SnonIntraSearchP and SnonIntraSearchQ); for intra-frequency measurements of a neighbor cell, in response to a determination that the serving cell quality is above the intra-frequency RSRP and RSRQ thresholds, remain in LP-WUS monitoring by the LP-WUR; and for inter-frequency measurements, in response to a determination that the serving cell quality is above the inter-frequency RSRP and RSRQ thresholds, turn on a main receiver and search for every layer of higher priority at least every inter-frequency period.

Example 19 is a computer-readable storage medium that stores instructions for execution by one or more processors of a user equipment (UE), the one or more processors to configure the UE to, when the instructions are executed: receive, from a 5th generation NodeB (gNB), control information that indicates which of a first configuration and a second configuration to use, the first configuration and the second configuration indicating measurement rules for use of a Low Power Wake Up Receiver (LP-WUR) and a main receiver to monitor a serving cell and inter-frequency and intra-frequency measurements of neighbor cells; and dependent on which of the first configuration and the second configuration is to be used and serving cell quality, select among the LP-WUR and the main receiver to monitor at least one of a low power synchronisation signal (LP-SS) or a low power wake-up signal (LP-WUS) for at least one of the serving cell or neighbor cells.

In Example 20, the subject matter of Example 19 includes, wherein: the first configuration is used for a network in which at least some neighbor cells do not support transmission of a corresponding LP-SS and LP-WUS, the second configuration is used for a network in which all neighbor cells support transmission of at least one of a corresponding LP-SS or LP-WUS, and the one or more processors to configure the UE to, when the instructions are executed: for the first configuration: in response to a determination that the serving cell quality is above intra-frequency Reference Signals Received Power (RSRP) and Reference Signals Received Quality (RSRQ) thresholds remain in LP-WUS monitoring by the LP-WUR, for intra-frequency measurements of a neighbor cell, and in response to a determination that the serving cell quality is above inter-frequency RSRP and RSRQ thresholds, turn on a main receiver and search for every layer of higher priority at least every inter-frequency period for inter-frequency measurements, and for the second configuration, use LP-WUS monitoring to perform serving cell measurements and all neighbor cell measurements.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to indicate one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. As indicated herein, although the term “a” is used herein, one or more of the associated elements may be used in different embodiments. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be considered to be interpreted as “includes at least” the elements that follow.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. An apparatus for a user equipment (UE), the apparatus comprising:
processing circuitry to configure the UE to, for a first configuration received from a 5^{th} generation NodeB (gNB):
use a Low Power Wake Up Receiver (LP-WUR) to monitor at least one of a low power synchronisation signal (LP-SS) or a low power wake-up signal (LP-WUS) for LP-WUS monitoring of a serving cell;
determine whether serving cell quality is above intra-frequency Reference Signals Received Power (RSRP) and Reference Signals Received Quality (RSRQ) thresholds (S_{IntraSearchP} and S_{IntraSearchQ}) and above inter-frequency RSRP and RSRQ thresholds (S_{nonIntraSearchP} and S_{nonIntraSearchQ});
for intra-frequency measurements of a neighbor cell, in response to a determination that the serving cell quality is above the intra-frequency RSRP and RSRQ thresholds, remain in LP-WUS monitoring by the LP-WUR; and
for inter-frequency measurements, in response to a determination that the serving cell quality is above the inter-frequency RSRP and RSRQ thresholds, turn on a main receiver and search for every layer of higher priority at least every inter-frequency period; and
a memory configured to store the serving cell quality.

2. The apparatus of claim 1, wherein the processing circuitry configures the UE to:
determine whether an overall period to switch from the LP-WUR to the main receiver and then switch back to the LP-WUR after a corresponding detection is performed is more than a switching period of 20 discontinuous reception (DRX) cycles with a DRX value=1.28 s; and
for inter-frequency measurements, in response to a determination that the overall period is larger than the switching period, switch from the LP-WUR to the main receiver for the corresponding detection and then switch back to the LP-WUR after the corresponding detection.

3. The apparatus of claim 1, wherein the inter-frequency period is 60*number of higher priority layers.

4. The apparatus of claim 1, wherein the processing circuitry configures the UE to:
for the inter-frequency measurements, in response to a determination that the serving cell quality is below the inter-frequency RSRP and RSRQ thresholds, turn on the main receiver and search and measure for frequency layers of higher, equal, or lower priority; and
in response to a determination that Srxlev>S_{IntraSearchP} and Squal>S_{IntraSearchQ}, switch between the main receiver and the LP-WUR for the inter-frequency measurement for higher priority layers, and perform radio resource management (RRM) using the LP-WUR for serving cell measurements.

5. The apparatus of claim 1, wherein the processing circuitry configures the UE to:
determine whether not-in-cell edge criterion, Srxlev>S_{SearchThresholdP} and Squal>S_{SearchThresholdQ}, is fulfilled;
in response to a determination that the not-in-cell edge criterion is fulfilled, use the main receiver to perform at least one of a relaxed intra-frequency radio resource management (RRM) or a relaxed inter-frequency RRM; and
in response to a determination that Srxlev>S_{IntraSearchP} and Squal>S_{IntraSearchQ}, switch between the main receiver and the LP-WUR for an inter-frequency measurement for higher priority layers while performing RRM in the LP-WUR for a serving cell measurement.

6. The apparatus of claim l, wherein the processing circuitry configures the UE to:
in response to a determination that a low mobility criterion is fulfilled while at least one of Srxlev≤S_{intraSearchP} or Squal≤S_{intraSearchQ}, use the main receiver to perform a relaxed intra-frequency radio resource management (RRM);
in response to a determination that the low mobility criterion is fulfilled while at least one of Srxlev≤S_{nonIntraSearchP} or Squal≤S_{nonIntraSearchQ}, use the main receiver to perform a relaxed inter-frequency RRM; and
in response to a determination that Srxlev>S_{IntraSearchP} and Squal>S_{IntraSearchQ}, switch between the main receiver and the LP-WUR for an inter-frequency measurement for higher priority layers while performing RRM in the LP-WUR for a serving cell measurement.

7. The apparatus of claim 1, wherein the processing circuitry configures the UE to extend use of the LP-WUR for radio resource management (RRM) to serving cell quality thresholds S_{SearchThresholdP} and S_{SearchThresholdP} in response to a determination that a relaxation factor is large enough to achieve power saving gain via switching between the LP-WUR and the main receiver for serving cell and neighbor cell measurements.

8. The apparatus of claim 1, wherein the processing circuitry configures the UE to use a first set of intra-frequency RSRP and RSRQ thresholds for LR-based radio resource management (RRM) to switch from the LP-WUR to the main receiver and a second set of intra-frequency RSRP and RSRQ thresholds for main receiver-based RRM to switch from the main receiver to the LP-WUR.

9. The apparatus of claim 8, wherein the processing circuitry configures the UE to receive the first set of intra-frequency RSRP and RSRQ thresholds in a System Information Broadcast.

10. The apparatus of claim 1, wherein at least some neighbor cells do not support transmission of a corresponding LP-SS and LP-WUS.

11. The apparatus of claim 1, wherein for a second configuration received from the gNB:
the processing circuitry configures the UE to use LP-WUS monitoring to perform serving cell measurements and all neighbor cell measurements; and
all neighbor cells support transmission of at least one of a corresponding LP-SS or LP-WUS.

12. The apparatus of claim 1, wherein, for a second configuration received from the gNB, the processing circuitry configures the UE to use different sets of intra-frequency RSRP and RSRQ thresholds and inter-frequency RSRP and RSRQ thresholds for the main receiver and the LP-WUR.

13. The apparatus of claim 12, wherein the processing circuitry configures the UE to use the different sets of intra-frequency RSRP and RSRQ thresholds to determine whether to perform an intra-frequency measurement, when to measure higher priority layers only for the inter-frequency measurement, and when to measure all layers for the inter-frequency measurement.

14. The apparatus of claim 12, wherein for relaxed measurement criteria, the processing circuitry configures the UE to use different not-in-cell-edge thresholds (S_{searchThresholdP} and S_{searchThresholdQ}) for not-in-cell-edge criterion and different parameter values for low mobility criterion for the main receiver than for the LP-WUR.

15. The apparatus of claim 1, wherein the processing circuitry configures the UE to receive, from the gNB, at least one of a System Information Broadcast or UE-specific radio resource control (RRC) signaling, an indication of which of the first configuration and a second configuration to use.

16. The apparatus of claim 1, wherein the processing circuitry configures the UE to:
determine whether at least one neighbor cell is not configured to transmit the LP-SS and LP-WUS; and
select among the first configuration and a second configuration dependent on a determination of whether the at least one neighbor cell is not configured to transmit the LP-SS and LP-WUS.

17. An apparatus configured to operate as a user equipment (UE), the apparatus comprising:
processing circuitry to configure the UE to:
receive, from a 5^{th} generation NodeB (gNB) in at least one of a System Information Broadcast or UE-specific radio resource control (RRC) signaling, control signaling that indicates which of a first configuration and a second configuration to use, the first configuration and the second configuration indicating measurement rules for use of a Low Power Wake Up Receiver (LP-WUR) and a main receiver to monitor a serving cell and inter-frequency and intra-frequency measurements of neighbor cells; and
dependent on which of the first configuration and the second configuration is to be used and serving cell quality, select among the LP-WUR and the main receiver to monitor at least one of a low power synchronisation signal (LP-SS) or a low power wake-up signal (LP-WUS) for at least one of the serving cell or neighbor cells; and
a memory configured to store the serving cell quality.

18. The apparatus of claim 17, wherein for the first configuration, the processing circuitry configures the UE to:
determine whether the serving cell quality is above intra-frequency Reference Signals Received Power (RSRP) and Reference Signals Received Quality (RSRQ) thresholds (S^{IntraSearchP} and S^{IntraSearchQ}) and above inter-frequency RSRP and RSRQ thresholds (S^{nonIntraSearchP} and S_{nonIntraSearchQ});
for intra-frequency measurements of a neighbor cell, in response to a determination that the serving cell quality is above the intra-frequency RSRP and RSRQ thresholds, remain in LP-WUS monitoring by the LP-WUR; and
for inter-frequency measurements, in response to a determination that the serving cell quality is above the inter-frequency RSRP and RSRQ thresholds, turn on a main receiver and search for every layer of higher priority at least every inter-frequency period.

19. A non-transitory computer-readable storage medium that stores instructions for execution by one or more processors of a user equipment (UE), the one or more processors to configure the UE to, when the instructions are executed:
receive, from a 5^{th} generation NodeB (gNB), control information that indicates which of a first configuration and a second configuration to use, the first configuration and the second configuration indicating measurement rules for use of a Low Power Wake Up Receiver (LP-WUR) and a main receiver to monitor a serving cell and inter-frequency and intra-frequency measurements of neighbor cells; and
dependent on which of the first configuration and the second configuration is to be used and serving cell quality, select among the LP-WUR and the main receiver to monitor at least one of a low power synchronisation signal (LP-SS) or a low power wake-up signal (LP-WUS) for at least one of the serving cell or neighbor cells.

20. The medium of claim 19, wherein:
the first configuration is used for a network in which at least some neighbor cells do not support transmission of a corresponding LP-SS and LP-WUS,
the second configuration is used for a network in which all neighbor cells support transmission of at least one of a corresponding LP-SS or LP-WUS, and the one or more processors to configure the UE to, when the instructions are executed:
for the first configuration:
in response to a determination that the serving cell quality is above intra-frequency Reference Signals Received Power (RSRP) and Reference Signals Received Quality (RSRQ) thresholds remain in LP-WUS monitoring by the LP-WUR, for intra-frequency measurements of a neighbor cell, and
in response to a determination that the serving cell quality is above inter-frequency RSRP and RSRQ thresholds, turn on a main receiver and search for every layer of higher priority at least every inter-frequency period for inter-frequency measurements, and
for the second configuration, use LP-WUS monitoring to perform serving cell measurements and all neighbor cell measurements.
